(19) United States
(12) Patent Application Publication
(10) Pub. No.: US 2018/0108330 A1
(43) Pub. Date: Apr. 19, 2018

(54) ELECTRONIC DEVICE WITH FLEXIBLE DISPLAY HAVING MULTIPLE VIEWING REGIONS

(71) Applicant: Lenovo (Singapore) Pte. Ltd., New Tech Park (SG)

(72) Inventors: Brian William Wallace, Wake Forest, NC (US); Roland Kamakau Albion Alo, JR., Raleigh, NC (US)

(21) Appl. No.: 15/296,443

(22) Filed: Oct. 18, 2016

(51) Int. Cl. G09G 5/14; G06F 1/16

(52) U.S. Cl. CPC G09G 5/14; G06F 1/1641; G06F 1/1652; G09G 2380/02; G06F 1/1649; G09G 2354/00; G06F 1/1643

(57) ABSTRACT

An electronic device, method and computer program product are provided. The electronic device comprises a main body unit including a user input, memory to store program instructions, and a processor to execute the program instructions. A display unit is moveably coupled to the main body unit. The display unit comprises a flexible display layer having primary and secondary viewing regions formed as a monolithic structure. The secondary viewing region is foldable relative to the primary viewing region. The processor defines boundaries for the primary and secondary viewing regions. The processor displays content on the primary and secondary viewing regions within the corresponding boundaries.

### FIELD

The present disclosure relates generally to electronic devices that include a flexible display and more particularly to a flexible display with multiple viewing regions.

### BACKGROUND OF THE INVENTION

Personal computers (PCs) and tablet devices have become fundamental tools both in personal life and business. The PC and tablet device are easy to operate and simple to carry. However, the PC and tablet device offer slightly different user experiences, which has led individuals to continue using both types of devices for different aspects of personal and business use. For example, the PC offers a larger user interface with a separate keyboard and display that facilitate extended, continuous use, while the tablet device offers a simpler user interface through a touchscreen. However, when the display on a conventional PC is closed, the device shuts down or enters a sleep mode. When shutdown or in the sleep mode, the PC is in operative and is unable to provide the user with new incoming information, such as notifications and the like.

On tablet devices, the touchscreen is easy to use while traveling and/or in public areas that do not afford a table or desk to hold a PC. Also, tablet devices facilitate joint viewing of a common display by a primary user and others (e.g. a customer, student, co-worker, family member, etc.). However, conventional tablet devices do not provide the same user interface experience as a conventional PC. Also, a touchscreen utilizes the touchscreen as the only display available and thus the touch sensitive display may become cluttered with fingerprints, rendering it more difficult to display content in certain lighting.

Convertible tablet personal computers (convertible PCs) have been proposed that offer the dual functionality of a PC and a tablet device. The convertible PC includes a display portion that is capable of rotating 360 degrees and folding back over the keyboard. However, convertible PCs also experience certain limitations. The convertible PC can be used in two ways, as a normal laptop personal computer (laptop PC) and a tablet PC. When such a convertible PC is changed to a tablet PC, the upward-facing keyboard in laptop PC mode becomes the downward-facing portion in tablet PC mode. Therefore, when the tablet PC is placed on a desk or other similar surface, the keyboard and click pad come into direct contact with the hard surface of the desk. Consequently, this decreases the stability of the device and also increases the likelihood of scratching or damaging the keyboard and click pad.

Further, convertible tablet personal computers require the user to rotate, slide, flip or otherwise turn the display between two different operative positions when switching between a conventional PC mode and a tablet mode. Complex interconnection assemblies are utilized to enable the display to rotate, slide, flip or otherwise turn. The complex interconnection assembly increases the potential for mechanical and/or electrical failures over an extended period of time.

A need remains for improved methods and devices that overcome the disadvantages discussed above and other disadvantages in conventional systems that will become apparent herein.

### SUMMARY

In accordance with embodiments herein, an electronic device is provided. The electronic device comprises a main body unit including a user input, memory to store program instructions, and a processor to execute the program instructions. A display unit is moveably coupled to the main body unit. The display unit comprises a flexible display layer having primary and secondary viewing regions formed as a monolithic structure. The secondary viewing region is foldable relative to the primary viewing region. The processor defines boundaries for the primary and secondary viewing regions. The processor displays content on the primary and secondary viewing regions within the corresponding boundaries.

Optionally, the flexible display layer may be rotatably coupled to the main body unit proximate to a first boundary of the primary viewing region. The secondary viewing region may be foldable along a fold line proximate to a second boundary of the primary viewing region. The display unit may be foldable about a primary lateral axis that extends laterally relative the user input and primary viewing region. The secondary viewing region may be foldable, relative to the primary viewing region, about a secondary lateral axis that is oriented orthogonal to the primary lateral axis. The primary and secondary viewing regions may be arranged in a stacked configuration with the primary and secondary lateral axes extending parallel to one another and located along bottom and top boundary of the primary viewing region.

Optionally, the primary and secondary viewing regions may be arranged in a side-by-side configuration with the secondary viewing regions foldable, relative to the primary viewing regions, about a vertical axis that is oriented perpendicular to the primary lateral axis. The secondary viewing region may be divided into first and second viewing regions that are formed as a monolithic structure with the primary viewing region. /the first and second viewing regions may be provided on opposite lateral sides of the primary viewing region.

Optionally, the flexible display layer may comprise an intermediate region between the primary and secondary viewing regions. The intermediate region may have a fold clearance area that is elongated along a lateral axis. The intermediate region may enable the secondary viewing region to be folded entirely inward until abutting against the primary viewing region and to be folded entirely outward until rear surfaces of the primary and secondary viewing regions are located proximate to one another. The device may further comprise a touch sensitive layer located over at least one of the first or secondary viewing regions of the flexible display layer. The touch sensitive layer may provide inputs to the processor.

In accordance with embodiments herein, a method is provided. The method comprises providing an electronic device comprising a display unit moveably coupled to a main body unit. The display unit comprises a flexible display layer having primary and secondary viewing regions formed as a monolithic structure. The secondary viewing region is foldable relative to the primary viewing region. Under control of one or more processors configured with specific executable program instructions, the method displays content on the primary and secondary viewing regions, respectively.

Optionally, the method may further comprise enabling the display unit to be foldable about a primary lateral axis that extends laterally relative the primary viewing region. The method may enable the secondary viewing region to be foldable, relative to the primary viewing region, about a secondary lateral axis that is oriented orthogonal to the primary lateral axis. The method may enable the secondary viewing region to be foldable entirely outward until rear surfaces of the primary and secondary viewing regions are located proximate to one another such that the primary and secondary viewing regions face in opposite directions.

Optionally, the method may comprise arranging the primary and secondary viewing regions in a configuration in which the primary viewing region is folded to a closed position against the main base unit, corresponding to an intermediate folded position while the secondary viewing region remains visible. The method may operate the secondary viewing region in a tablet mode when in the intermediate folded position. The method may arrange the primary and secondary viewing regions to be folded to closed positions against front and back surfaces of the main base unit.

Optionally, the primary and secondary viewing regions may wrap about top and bottom edges of the main base unit when in the closed position. The primary and secondary viewing regions may wrap about top and side edges of the main base unit when in the closed position. The secondary viewing region may include first and second viewing regions provided along opposite sides of the primary viewing region. The first and second viewing regions may wrap about opposite side edges of the main base unit when in the closed position.

In accordance with embodiments herein, a computer program product is provided. The computer program product comprises a non-signal computer readable storage medium comprising computer executable code to map sections of a display memory to primary and secondary viewing regions of a flexible display layer. The primary and secondary viewing regions being formed as a monolithic structure. The secondary viewing region is foldable relative to the primary viewing region. The computer program product writes content to corresponding sections of the display memory in connection with displaying the content on the primary and secondary viewing regions.

Optionally, the computer program product may further comprise executable codes to identify a mode of operation and map the sections of the display memory based on the mode of operation. The computer program product may further comprise executable codes to activate a touch sensitive layer proximate the secondary viewing region based on a mode of operation. By way of example, the first mode may represent one of an initial mode, a standard mode, a presentation mode, a tablet mode, a notifications mode and/or a user query mode, while the second mode represents a different one of the initial mode, standard mode, presentation mode, tablet mode, notifications mode and/or user query mode. Optionally, the first/primary viewing region may not include a touch sensitive layer, thereby avoiding excessive fingerprints being created on the primary viewing region.

### BRIEF DESCRIPTION OF THE DRAWINGS

FIG. 1 is a perspective view of an electronic device formed in accordance with embodiments herein.

FIG. 2 illustrates a top plan view of the display unit in accordance with embodiments herein.

FIG. 3A illustrates an electronic device having a main base unit that is foldably attached to a display unit.

FIG. 3B illustrates an electronic device having a main base unit that is foldably attached to a display unit in accordance with embodiments herein.

FIG. 4A illustrates an electronic device when folded between different positions in accordance with an embodiment herein.

FIG. 4B illustrates an electronic device when folded between open and closed positions in accordance with an embodiment herein.

FIG. 4C illustrates an electronic device when folded between different positions in accordance with an embodiment herein.

FIG. 5A illustrates an electronic device formed in accordance with an alternative embodiment.

FIG. 5B illustrates the device when in a closed storage position in accordance with embodiments herein.

FIG. 5C illustrates the device when in an open position with the main base unit connected to the display unit in accordance with embodiments herein.

FIG. 6 illustrates a process for configuring a display unit based on an embodiment herein.

FIG. 7 illustrates a graphical representation of a mapping relation between display memory sections and viewing areas utilized in accordance with an embodiment herein.

FIG. 8 illustrates a simplified block diagram of internal components of the electronic device configured to manage content display to different regions of a flexible display in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The terms “content”, “display content and “visual content,” as used throughout, shall generally refer to any and all textual, graphical, image or video information or data that may be presented on a display of an electronic device. The content may represent various types of incoming and outgoing textual, graphical, image and video content including, but not limited to, calendar events, email, text messages, alerts, still images, video, advertisements, company information (e.g., company logo, advertisements), screen saver, personalized visual information and the like.

The term “flexible display layer” represents a monolithic structure that comprises one or more organic layers arranged between an array of electrodes. The term “flexible display layer” does not include liquid crystal displays (LCDs). Instead, the flexible display layer may comprise one or more organic light emitting diode layers that are deposited on one another, and electrodes are provided on opposite sides thereof, to create the monolithic structure. The electrodes are arranged with cathodes and anodes on opposite sides of the monolithic structure. The cathodes may be reflective (e.g. as in an OLED) or transparent (as in a transparent OLED).

The term “orthogonal” as used throughout, shall generally refer to perpendicular and/or parallel orientations between items of interest. For example, fold lines, axes and the like shall be described as perpendicular and or parallel (collectively, orthogonal) to one another and/or other structures.

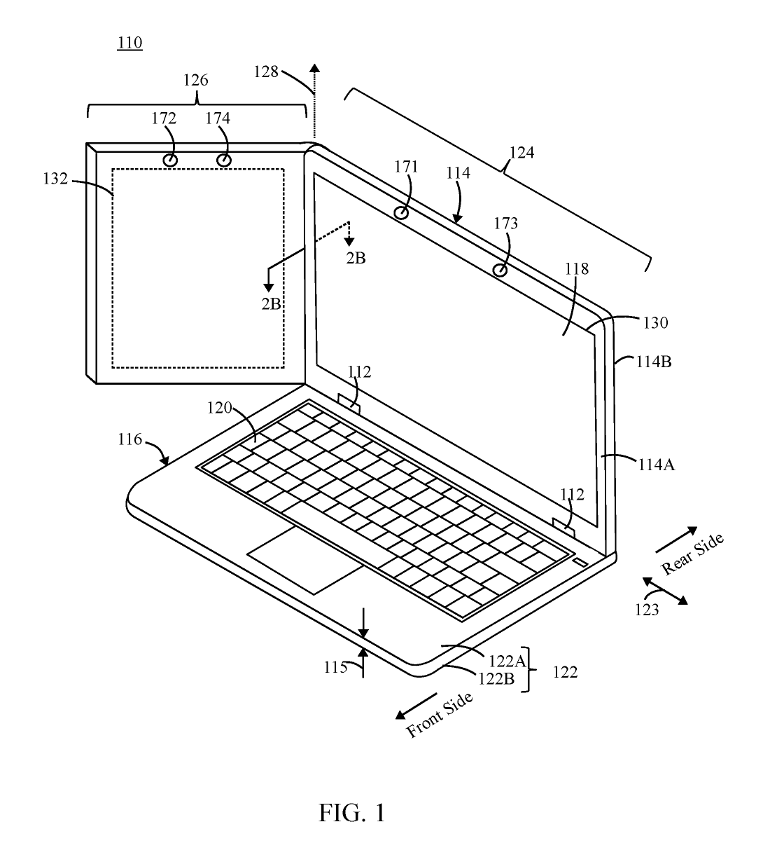

FIG. 1 is a perspective view of an electronic device 110 formed according to one embodiment herein, showing a state where a display unit 114 is opened from a main body unit 116 by means of hinges 112 so that both will be essentially perpendicular to each other. The display unit 114 is attached to the main body unit 116 so as to be freely opened and closed. The electronic device 110 can be suitably used as a laptop PC when the display unit 114 is angled relative to the main body unit 116. Note that, in addition to such a convertible PC, the embodiments herein can be suitably applied to electronic devices such as cellular phones, a smart phones, and various electronic organizers.

For descriptive convenience, it is assumed that the display unit 114 is completely closed to the main body unit 116 at a 0-degree angle position between the main body unit 116 and the display unit 114 by means of hinges 112, where the display 118 and the keyboard 120 face each other. In relation to a user who looks directly at the front face of the display unit 114, the side closest to the user is called the front side 114A (forward) and side furthest away from the user is called the rear side 114B (rearward). The thickness 115 of the main body unit 116 will be referred to as the vertical direction and the width will be referred to as the lateral direction.

Throughout the present description, the terms “vertical” and “lateral” shall define directions with respect to the display and keyboard of the device. The term “lateral” shall refer to a direction extending transversely across the user input region (e.g., from left to right or from right to left, with respect to a keyboard). In the example of FIG. 1, the lateral direction is illustrated by lateral axis 123 which extends through the hinges 112. The primary display segment 124 rotates at one edge about the hinges 112 and the lateral axis 123. The term “vertical” shall refer to a direction extending outward from the user input (e.g., keyboard) such as in a direction non-parallel to the lateral direction. In the example of FIG. 1, the vertical direction is illustrated by vertical axis 128 is oriented perpendicular to the lateral axis 123, with the vertical axis 128 extending upward along the interface between the primary and secondary display segments 124, 126.

The display unit 114 contains the display 118 and the main body unit 116 containing the keyboard 120. The display 118 represents a flexible display layer such as an organic light-emitting diodes (OLED) display. The display unit 114 and the main body unit 116 are constantly connected and rotated, from the 0-degree position to any other angular position, by the hinge 112. The display unit 114 is electrically connected to the main body unit 116 by a cable, not shown, through the hinge 112. Optionally, the hinge 112 may be formed from a section of the flexible display layer alone or in combination with other structures. The main body unit 116 is configured such that the hinge 112 is located at the rear edge portion of the main body housing 122. The main body housing 122 is formed into the shape of a flat box and contains various electronic components, not shown, such as a substrate, an arithmetic unit, a processor and a memory that are housed therein. The main body housing 122 includes upper and lower covers 122A and 122B.

The main base unit 116 houses a keyboard, processor, memory as well as other components based on the nature and functionality to be provided. The display unit 114 is rotated relative to the main base unit 116 through the hinge (112 in FIG. 1) to an open position. When in the open position, the front surface 114A of the display unit 114 faces in the direction of the keyboard 120 and is visible to the user of the keyboard 120.

The display unit 114 includes primary and secondary display segments 124, 126. The secondary display segment 126 is positioned laterally along one side of the primary display segment 124 in a side-by-side configuration. The secondary display segment 126 is foldable relative to the primary display segment 124 about a vertical axis 128. As explained herein, the secondary display segment 126 may be positioned in alternative locations and foldable in other directions. As explained herein, more than one secondary display segment may be utilized.

The primary display segment 124 includes one or more microphones 171 and one or more cameras 173. The microphone 171 and camera 171 are directed outward to face in a direction toward the keyboard to provide a field of view and audio field directed outward from the front side 114A. The secondary display segment 126 may include one or more microphones 172 and one or more cameras 174. The microphone 172 and camera 174 are directed outward to face in various directions depending upon the orientation of the secondary display segment 124. For example by bending the secondary display segment 124, the microphone and camera 172, 174 may be directed in a direction toward the keyboard or in a direction away from the keyboard to provide flexibility to adjust a field of view and audio field while maintaining the keyboard in a desired orientation relative to a user.

In accordance with embodiments herein, one or more processors within the device 110 define boundaries for viewing regions within the primary and secondary display segments 124, 126. In FIG. 1, a boundary segment 130 is illustrated to surround a primary viewing region 147, while a boundary segment 132 is illustrated to surround a secondary viewing region 149. It is recognized that the boundary segments 130, 132 may define alternative sizes and shapes and include all or only a portion of the primary and secondary display segments 124, 126.

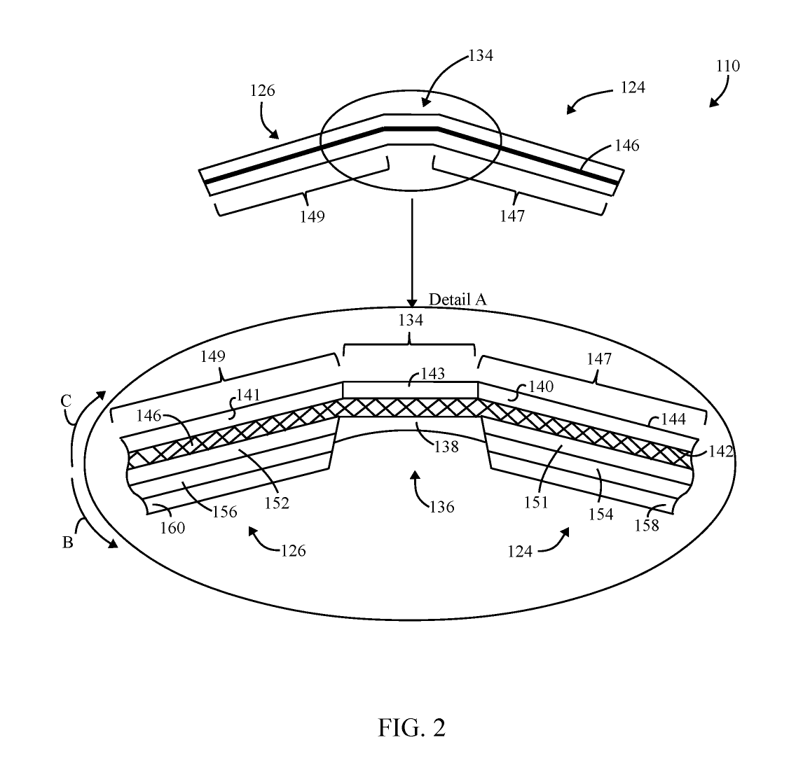

FIG. 2 illustrates a top plan view of the display unit 114 of FIG. 1. The display unit 114 includes the primary and secondary display segments 124 and 126 folded at an obtuse angle with one another bent at an intermediate segment 134. In addition, the intermediate segment 134, and adjoining portions of the primary and secondary display segments 124, 126, are illustrated in cross-section in greater detail at detail A. With reference to detail A, the display unit 114 comprises first and second core layers 140, 141 provided within the primary and secondary display segments 124, 126. The first and second core layers 140, 141 are formed from a rigid material, such as aluminum, a polymer alloy and the like. The first and second core layers 140, 141 may be formed with a predetermined shape, such as substantially planar shapes, predetermined bent shapes and the like. The first and second core layers 140, 141 provide structural integrity and durability to the corresponding primary and secondary display segments 124, 126, respectively. Optionally, the first and second core layers 140, 141 may have a slight degree of flexibility to permit the primary and secondary display segments 124, 126 to slightly bend. Additionally or alternatively, the first and second core layers 140, 141 may be formed of a material having a predetermined degree of position memory to enable the primary and secondary display segments 124, 126 to bend when forces are applied thereto (e.g. when packed in a backpack, briefcase, set on, stepped on, dropped, bumped, etc.), but return to an initial unbiased planar shape when the force is removed.

The first and second core layers 140, 141 have opposed first and second sides 142, 144 facing the front and rear sides 114A and 114B of the display unit 114, respectively. A flexible display layer 146 is mounted to the first sides 142 on the first and second core layers 140, 141. The flexible display layer 146 is formed as one continuous monolithic structure. As explained herein, the flexible display layer 146 may be functionally segmented into various viewing regions that are managed independently to display desired content. In the example of FIG. 2, the flexible display layer 146 includes the primary and secondary viewing regions 147, 149 (corresponding to the primary and secondary display segments 124, 126) that are formed integral with one another and as a monolithic structure. The primary and secondary viewing regions 147, 149 are managed independently and may display the same or different content. The primary viewing region 147 is mounted on the first side 142 of the first core layer 140, while the secondary viewing region 149 is mounted on the first side of the second core layer 141. The first and second core layers 140, 141 maintain the corresponding primary and secondary viewing regions 147, 149 in a substantially flat or other predefined planar or curved orientation (corresponding to the shape of the core layers 140, 141).

The core layers 140 and 141 are joined at a hinge mechanism 143 that is flexible and permits the core layers 140 and 141 to rotate relative to one another in the directions of arrows B and C. FIG. 2 illustrates the core layers 140 and 141 (and the primary and secondary display segments 124 and 126) oriented at an obtuse angle with respect to one another. Additionally, as described below in connection with various figures, the core layers 140, 141 may be pivoted to numerous alternative angular orientations, where the rotation range is held by the hinge mechanism 143. For example, the secondary display segment 126 may be folded entirely inward (in the direction of arrow B) until abutting against the primary display segment 124 (e.g. in accordance with a closed position). Additionally or alternatively, the secondary display segment 126 may fold entirely outward (in the direction of arrow C) until rear surfaces of the core layers 140, 141 (corresponding to rear surfaces of the primary and secondary display segments 124, 126) are located proximate to, or abut against, one another). When fully opened to the presentation or tablet positions, the primary and secondary display segments 124, 126 face in opposite directions. When foldable entirely outward until rear surfaces of the primary and secondary display 124, 126 segments are located proximate to one another such that the primary and secondary viewing regions 147, 149 face in opposite directions.

The hinge mechanism 143 may be formed from various materials. For example, the hinge mechanism 143 may represent a magnetic hinge assembly that maintains any desired angle once the primary and secondary display segments are adjusted manually to the desired angle. U.S. Pat. Nos. 6,869,180; 6,939,003 and 7,229,168 describe examples of magnetic hinges that may be used, all of which are expressly incorporated by reference in their entirety.

Optionally, the hinge assembly 143 may be formed from shape memory alloy wires that extend through the intermediate segment.

Detail A in FIG. 2 also illustrates additional layers that may be provided within the display unit 110. For example, touch sensitive layers 151 and 152 may be located over one or more of the primary and secondary viewing regions 147, 149 of the flexible display layer 146. The touch sensitive layers 151, 152 are configured to provide touch inputs to the processor. As one example, one or both of the touch sensitive layers 151, 152 may provide a dual touch layer that affords redundancy to facilitate survival after accidents. Optionally, one or both of the touch sensitive layers 151 and 152 may be omitted. For example, the touch sensitive layer 151 may be omitted, while the touch sensitive layer 152 may be retained, in order that the front side 114A of the display unit 114 is not touch sensitive, while the rear side 114B is touch sensitive. The touch sensitive layers 151, 152 may be switched between active and inactive states, such as based on a mode of operation.

Optionally, the display unit 114 may include one or more lenses provided over select regions thereof. Various combinations of lenses may be utilized. As one example, interior lenses 154 and 156 may be provided over the touch sensitive layers 151 and 152, respectively. The interior lenses 154 and 156 may be made of various types of material, such as polycarbonate plastic (e.g. a shatter resistant material). Exterior lenses 158 and 160 may be provided over the interior lenses 154 and 156, respectively. The exterior lenses 158, 160 may be formed of plastic or another material having a desired protective properties. For example, the exterior lenses may be formed of a hard coat material that is scratch resistant and provides antiglare. The first and second interior lens 154, 156 are secured over the primary and secondary viewing regions 147, 149, respectively, and the first and second exterior protective lenses 158, 160 are secured over the first and second interior lenses 154, 156, respectively, in various manners.

Optionally, the display unit 114 may comprise a single first lens located over the primary viewing region 147 and a single second lens located over the secondary viewing region 149. It is recognized that additional or fewer lenses may be utilized with additional or alternative properties. Optionally, one or more layers 151-160 may be formed with glass, provided the glass exhibits desired characteristics, such as being thin, light and damage resistant as one example, alkali-aluminosilicate sheet glass may be used as cover glass for portable electronic devices. Examples of types of glass include Gorilla glass by Corning, Dragontrail glass by Asahi Glass Co. and Xensation glass by Schott AG. However, in at least some embodiments, none of the layers 151-160 are formed from glass, in order to prevent shattering or cracking for an extended period of time. Optionally, one or more of the layers 151-160 may be formed of a material exhibiting shock absorbing properties.

The touch sensitive layer 151, and lenses 154, 158 within the primary display segment 124 are separated (at the intermediate segment 134) from the touch sensitive layer 152, and lenses 156, 160 in the secondary display segment 126 to provide a fold clearance area 136 there between. Optionally, a protective layer 138 (e.g. a flexible silicon, polymer or plastic) may be provided over the flexible display layer 146 within the fold clearance area 136 of the intermediate segment 134 to cover the flexible display layer 146. The fold clearance area 136 is shaped and dimensioned to enable the secondary display segment 126 to rotate relative to the primary display segment 124 over a predetermined folding or bending range. For example, as described herein in connection with the various figures, the secondary display segment 126 may be folded forward or backward until abutting flush against front or rear surfaces of the primary display segment 124. For example, the intermediate region 134 may enable the secondary display segment 126 to be folded entirely inward until abutting against the primary display segment 124 and to be folded entirely outward until rear surfaces of the primary and secondary display segments 124, 126 are located proximate to, or abutting against, one another.

Optionally, a single common lens may be provided over the primary viewing region 147 and the rear viewing region 150. For example, the lens may be formed of plastic or other material that may be flexible to follow the shape of the flexible display layer 146 that extends about an edge of the display unit.

The flexible display layer 146 may be formed as a film or other thin layer, and is organized into digital pixels. The pixels are arranged in an array of rows and columns that extends across an entire length, and width of the flexible display layer. The pixels of the flexible display layer 146 are mapped in any desired manner in order to divide presentation of desired types of content in the various regions. As one example, the flexible display layer 146 may be formed from an array of OLEDs.

OLEDs are light-emitting diodes (LED) in which the emissive electroluminescent layer is a film of organic compound that emits light in response to an electric current. There are two main families of OLED, namely small molecule based OLEDs and polymer based OLEDs. Adding mobile ions to an OLED creates a light-emitting electrochemical cell (LEC) which has a slightly different mode of operation. OLED displays can use either passive-matrix (PMOLED) or active-matrix (AMOLED) addressing schemes. Active-matrix OLEDs (AMOLED) utilize a thin-film transistor backplane to switch individuals pixel on or off, but allow for higher resolution and larger display sizes. The OLED display works without a backlight. Thus, the OLED can display deep black levels and can be thinner and lighter than a liquid crystal display (LCD). In low ambient light conditions (such as a dark room), an OLED screen can achieve a higher contrast ratio than an LCD, regardless of whether the LCD uses cold cathode fluorescent lamps or an LED backlight.

A OLED layer may be composed of a layer of organic materials situated between electrodes (e.g., anodes and cathodes), all deposited on a substrate. The organic molecules are electrically conductive as a result of delocalization of pi electrons caused by conjugation over part or all of the molecule. These materials have conductivity levels ranging from insulators to conductors, and are therefore considered organic semiconductors. The highest occupied and lowest unoccupied molecular orbitals (HOMO and LUMO) of organic semiconductors are analogous to the valence and conduction bands of inorganic semiconductors.

Optionally, the flexible display layer 140 may include two or more layers of OLEDs in order to improve device efficiency. Optionally, different materials may be chosen to aid charge injection at electrodes by providing a more gradual electronic profile, or block a charge from reaching the opposite electrode and being wasted. Many modern OLEDs incorporate a simple bilayer structure, that includes a conductive layer and an emissive layer. During operation, a voltage is applied across select OLED pixels such that the anode is positive with respect to the cathode. A current of electrons flows through the device from cathode to anode, as electrons are injected into the LUMO of the organic layer at the cathode and withdrawn from the HOMO at the anode.

It is recognized that the display unit 114 may include additional layers and other structures. Optionally, the display unit 114 may include fewer layers and fewer structures than described herein. Optionally, the display unit may be formed in numerous alternative configurations. For example, secondary display segments may extend from various edges of the primary display unit. Additionally or alternatively, more than one secondary display unit may be provided and formed to extend from various combinations of the edges of the primary display segment.

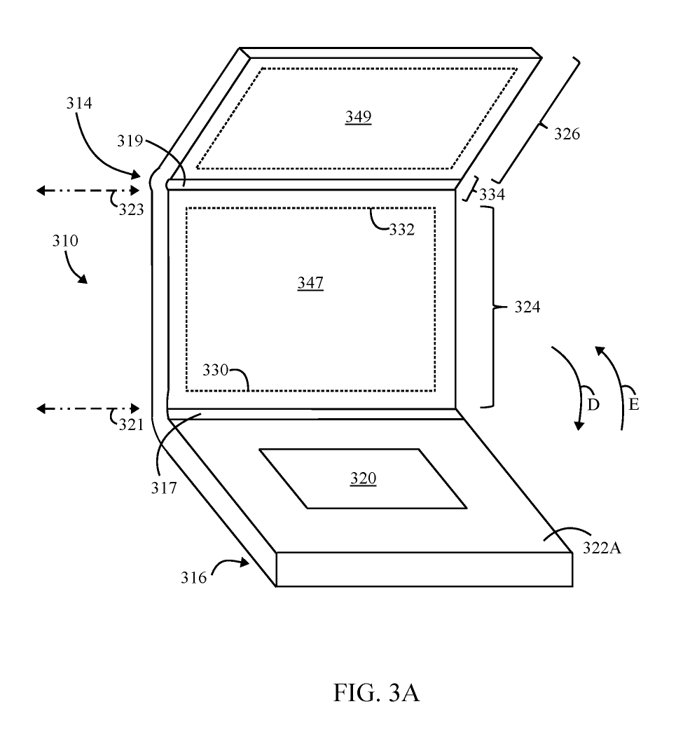

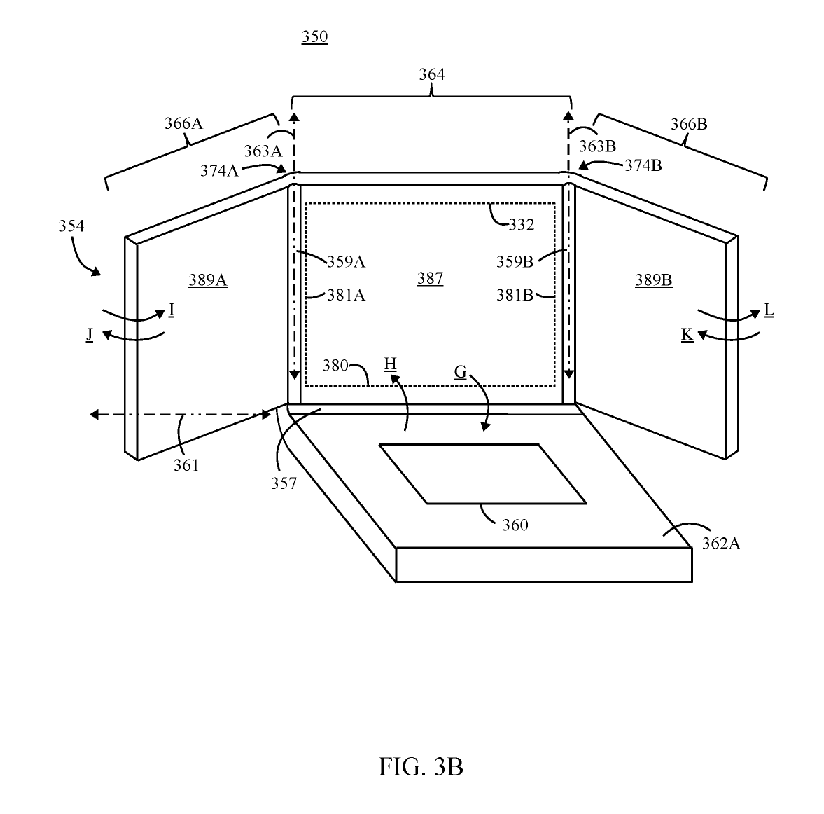

FIGS. 3A-3B illustrate perspective views of display units formed in accordance with alternative embodiments, including various positions to which the segments of the display unit may be folded.

FIG. 3A illustrates an electronic device 310 having a main base unit 316 that is foldably attached to a display unit 314. The display unit 314 includes a primary display segment 324 and a secondary display segment 326 that are stacked vertically above one another. The primary display segment 324 includes a primary viewing region 347 from a flexible display layer. The secondary display segment includes a secondary viewing region 349 from the same flexible display layer. The secondary display segment 326 is vertically stacked above the primary display segment 324 relative to the main base unit 316 and the keyboard 320. The primary display segment 324 is attached through a connection interface 317 to the main body unit 316 in various manners. The connection interface 317 bends or folds about a primary lateral axis 321 to allow the primary display segment 324 to be rotated in the direction of arrow D toward, and in the direction of arrow E away from, a keyboard 320 provided on an upper cover 322A of the main base unit 316.

The secondary display segment 326 is configured to fold along an intermediate segment 334 which has a fold clearance area in a fold line 319. The intermediate segment 334 generally corresponds to the intermediate segment 134 described above in connection with FIG. 2. In the embodiment of FIG. 3A, the fold line 319 is oriented to extend along a secondary lateral axis 323 that is oriented substantially parallel to, and located vertically above, the primary lateral axis 321. The primary lateral axis 321 (corresponding to the connection interface 317) is located along a lower or bottom boundary 330 of the primary viewing region 347, while the secondary lateral axis 323 (corresponding to fold line 319) is positioned along an upper or top boundary 332 of the primary viewing region 347. Optionally, the secondary lateral axis 323 may be oriented at other desired angles relative to the primary lateral axis 321.

The device 310 is operable in various modes to display the same or different content in the primary and secondary viewing regions 347, 349. For example, the device 310 may operate in a dual display mode, in which different first and second content are presented in the primary and secondary viewing regions 347, 349. For example, the user may wish to view different documents or perform different functions or applications in parallel. To do so, the user may adjust the appearance of the display, such as to extend the display across the primary and secondary viewing regions 347, 349. As another example, the device 310 may operate in a presentation mode, such that the same or related content is displayed on the primary and secondary viewing regions 347, 349. By presenting the same content on the primary and secondary viewing regions 347, 349, a user is able to provide a presentation (on the secondary viewing region 349) to one or more other individuals who may not be able to see the primary viewing region 347 which may be blocked by the user.

Non-limiting examples for applications, in which a presentation mode may be utilized, include presenting material in a business environment to colleagues, management, customers, etc. As another example, the presentation mode allows educational and/or instructional material to be presented to students, users and others in educational environments as another example, the presentation mode may be utilized in connection with sales, such as to provide marketing and other material to customers, vendors and the like. The content presented on the secondary viewing region 349 may be the same as or different from the content presented on the primary viewing region 347.

FIG. 3B illustrates an electronic device 350 having a main base unit 356 that is foldably attached to a display unit 354. The display unit 354 includes a primary display segment 364 and a secondary display segment divided into first and second lateral display segments 366A and 366B (that collectively define the secondary display segment). The primary display segment 364 includes a primary viewing region 387 from a flexible display layer. The first and second lateral display segments 366A, 366B include first and second lateral viewing regions 389A, 389B (that collectively defined a secondary viewing region). The first and second viewing regions 389A, 389B are formed as a monolithic structure with the primary viewing region 387 as part of the same flexible display layer. The first and second viewing regions 389A, 389B are provided on opposite lateral sides of the primary viewing region 387. The primary display segment 364 is attached through a connection interface 357 to the main body unit 356 in various manners. The connection interface 357 bends or folds about a primary lateral axis 361 to allow the primary display segment 364 to be rotated in the direction of arrow G toward, and in the direction of arrow H away from, a keyboard 360 provided on an upper cover 362A of the main base unit 356.

The first and second lateral display segments 366A, 366B are configured to fold along corresponding intermediate segments 374A, 374B in fold clearance areas which define corresponding fold lines 359A, 359B. The intermediate segments 374A, 374B generally correspond to the intermediate segment 134 described above in connection with FIG. 2. In the embodiment of FIG. 3B, the fold lines 359A, 359B are oriented to extend along corresponding first and second vertical axes 363A, 363B that are oriented substantially perpendicular to the primary lateral axis 321. The primary lateral axis 361 (corresponding to the connection interface 357) is located along a lower or bottom boundary 380 of the primary viewing region 387, while the first and second vertical axes 363A, 363B (corresponding to fold lines 359A, 359B) are positioned along opposite side boundaries 381A, 381B of the primary viewing region 387. The first lateral display segment 366A may be folded about the first vertical axis 363A in the direction of arrow I until the first lateral viewing region 389A is oriented at a desired angle relative to the primary viewing region 387. The intermediate segment 363A may allow the first lateral display segment 366A to be folded entirely inward until the viewing regions 389A and 387 about against one another. Additionally or alternatively, the intermediate segment 363A may be configured to enable the first lateral display segment 363A to be enfolded entirely outward (in the direction of arrow J) until the back surface thereof abuts against the back surface of the primary display segment 364.

The second lateral display segment 366B may be configured in a similar manner to the first lateral display segment 366A, whereby the second lateral display segment 366B may be rotated to any desired angle relative to the primary display segment 364. The second lateral display segment 366B may be rotated inward in the direction of arrow K to any desired orientation, including to a close position such that lateral viewing region 389B abuts against the primary viewing region 387. The second lateral display segment 366B may also be rotated entirely outward in the direction of arrow L until the rear surface thereof abuts against the back surface of the primary display segment 364.

The device 350 is operable in various modes to display the same or different content in the primary, first lateral and second lateral viewing regions 387, 389A, 389B. For example, the device 350 may operate in a triple display mode, in which different first, second and third content are presented in the primary, first lateral and second lateral viewing regions 387, 389A, 389B. For example, the user may wish to view different documents or perform different functions or applications in parallel. Optionally, the primary, first lateral and lateral viewing regions 387, 389A, 389B may be formatted in an extended view mode, in which the primary, first lateral and second lateral viewing regions 387, 389A, 389B may display adjoining portions of one continuous content such as a video, movie, picture and the like. Optionally, the first and second lateral display segments 366A, 366B may be rotated in the directions of arrows J and L, respectively until facing away from the primary viewing region 387 to allow individuals on a backside of the device 310 to view content thereon. For example, the primary display segment 364 and the first and second lateral display segments 366A, 366B may be oriented in a generally triangular orientation such that the viewing regions 387, 389A, 389B are oriented to face in different directions (e.g., corresponding to the three legs of a triangle), thereby providing a substantially 360° viewing configuration (e.g., for providing presentations to multiple people, for presenting marketing material, for an education environment and the like).

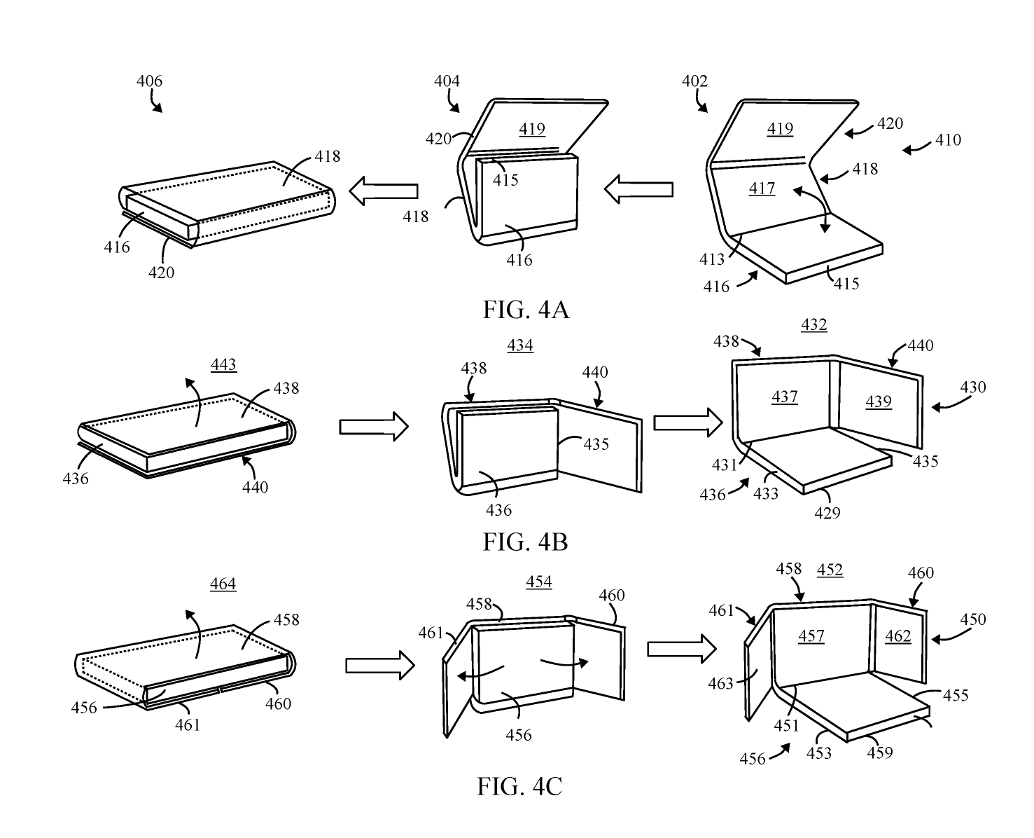

FIGS. 4A-4C illustrate perspective views of electronic devices with display units formed in accordance with alternative embodiments, including various positions to which the segments of the display unit may be folded.

FIG. 4A illustrates an electronic device 410 when folded between different positions in accordance with an embodiment herein. Beginning with an open position 402, the device 410 includes a main base unit 416 joined to primary and secondary display segments 418, 420. The main base unit 416 includes top edges 413 and bottom edges 415. The primary display segment 418 is connected along the top edge 413 of the main base unit 416. The primary and secondary display segments 418, 420 include primary and secondary viewing regions 417, 419. The primary and secondary display segments 418 and 420 are joined in a stacked manner such that the secondary display segment 420 is provided along the top border of the viewing region on the primary display segment 418.

The device 410 may be folded to an intermediate folded position 404 in which the primary display segment 418 is folded to a close position with the primary viewing region 417 folded against a user input (e.g., keyboard) of the main base unit 416. In the intermediate folded position 404, the secondary display segment 420 is still visible and may be operated in a tablet mode. The device 410 may be folded from the intermediate folded position 404 to a closed position 406 in which the secondary display segment 420 is folded to a closed position against the back surface of the main base unit 416

The secondary display segment 420 is folded downward over a bottom edge 415 of the main base unit 416. The bottom edge 415 is located along an edge opposite to the interconnection between the main base unit 416 and the primary display segment 418. In the closed position 406, the viewing region of the secondary display segment 420 is not visible and is folded to a closed position. In the closed position, the primary and secondary display segments 418, 420 are located on opposite sides of and sandwich the main base unit 416 there between.

As shown in FIG. 4A, the device 410 may be folded between open and close positions by wrapping the primary and secondary display segments 418, 420 around the main base unit 416. Optionally, one or both of the primary and secondary display segments 418, 420 may be wrapped in the opposite direction to the directions illustrated in FIG. 4A. When wrapped in the opposite direction, one or both of the primary and secondary viewing regions 417, 419 are exposed with backsides thereof folded against the main base unit 416. For example, it may be desirable to wrap the display segments 418, 420 in the opposite direction when it is desirable to use one or both of the primary and secondary viewing regions 417, 419 in a tablet mode (e.g. with an active touch sensitive layer therein). As a further example, one of the viewing regions 417, 419 may be operated in a tablet mode with a touch sensitive layer activated, while the opposite one of the viewing regions 417, 419 is inactive or merely in a display mode (e.g. without a touch sensitive layer or by inactivating the touch sensitive layer).

FIG. 4B illustrates an electronic device 430 when folded between open and closed positions in accordance with an embodiment herein. Beginning with an open position 432, the device 430 includes a main base unit 436 that is joined to primary and secondary display segments 438 and 440. The main base unit 436 includes opposite side edges 433 and 435 and top and bottom edges 431 and 429. The primary display segment 438 is connected to the top edge 431 of the main base unit 436. The primary and secondary display segments 438 and 440 include primary and secondary viewing regions 437 and 439. The primary and secondary display segments 438, 440 are oriented in a side-by-side arrangement such that the secondary display segment 440 is positioned laterally to one side of the primary display segment 438.

The device 430 may be folded to an intermediate folded position 434 in which the primary display segment 438 is folded to a closed position with the primary viewing region 417 folded against a keyboard of the main base unit 436. In the intermediate folded position 434, the secondary display segment 440 is still visible and may be utilized in a tablet mode. The device 430 may be folded from the intermediate folded position 434 to a closed position 443 in which the secondary display segment 440 is folded to a closed position against the back surface of the main base unit 436. The secondary display segment 440 is folded over a lateral edge 435 of the main base unit 436. The lateral edge 435 is located along one side of the keyboard. In the closed position 436, the viewing region of the secondary display segment 440 is not visible and is folded to a closed position. In the closed position, the primary and secondary display segments 438, 440 are located on opposite sides of, and sandwich, the main base unit 436 there between.

As shown in FIG. 4B, the device 430 may be folded between open and close positions by wrapping the primary display segment 438 in one direction (e.g. a vertical direction) around the main base unit 436, and wrapping the secondary display segment 440 in another direction (e.g. a lateral direction) around the main base unit 436. Optionally, one or both of the primary and secondary display segments 438, 440 may be wrapped in the opposite direction to the directions illustrated in FIG. 4B. When wrapped in the opposite direction, one or both of the primary and secondary viewing regions 437, 439 are exposed with backsides thereof folded against the main base unit 436. For example, it may be desirable to wrap the display segments 438, 440 in the opposite direction when it is desirable to use one or both of the primary and secondary viewing regions 437, 439 in a tablet mode (e.g. with an active touch sensitive layer therein). As a further example, one of the viewing regions 437, 439 may be operated in a tablet mode with a touch sensitive layer activated, while the opposite one of the viewing regions 437, 439 is inactive or merely in a display mode (e.g. without a touch sensitive layer or by the activating the touch sensitive layer).

FIG. 4C illustrates an electronic device 450 when folded between different positions in accordance with an embodiment herein. Beginning with an open position 452, the device 450 includes a main base unit 456 joined to primary, first lateral and second lateral display segments 458, 460, 461. The main base unit 456 includes top and bottom edges 451 and 459 and side edges 453 and 455. The primary, first lateral and second lateral display segments 458, 460, 461 include primary, first lateral and second lateral viewing regions 457, 462, 463. The primary, first lateral and second lateral display segments 458, 460, 461 are joined in a side-by-side manner such that the first and second lateral display segments 460, 461 are provided on opposite sides of the primary display segment 458. A bottom edge of the primary display segment 458 is connected to the top edge 451 of the main base unit 456 in a manner described herein.

The electronic device 450 may be folded to intermediate folded position 454 in which the primary display segment 458 is folded to a closed position with the primary viewing region 457 folded against the keyboard of the main base unit 456. In the intermediate folded position 454, the first and second lateral display segments 460, 461 are still visible and may be utilized in a tablet mode. The device 450 may be folded from the intermediate folded position 454 to a closed position 464 in which the first and second lateral display segments 460, 461 are folded to a closed position against the back surface of the main base unit 456. When in the closed position 464, the first and second lateral display segments 460, 461 are folded over the side edges 453, 455 of the main base unit 456. In the closed position 464, the viewing regions of the first and second lateral display segments 460, 461 are not visible and are folded to a closed position. In the closed position, the primary display segment 458 is located on opposite side of the main base unit 456 as the first and second lateral display segments 460, 461.

Optionally, one or more of the primary, first lateral and second lateral display segments 458, 460, 461 may be wrapped in the opposite direction to the directions illustrated in FIG. 4C. When wrapped in the opposite direction, one or more of the primary, first lateral and second lateral display regions 457, 462, 463 are exposed with backsides thereof folded against the main base unit 456. As explained herein, it may be desirable to fold the primary, first lateral and second lateral display segments 458, 460, 461 in various directions to use one or more of the primary, first lateral and second lateral display segments 458, 460, 461 in a tablet mode.

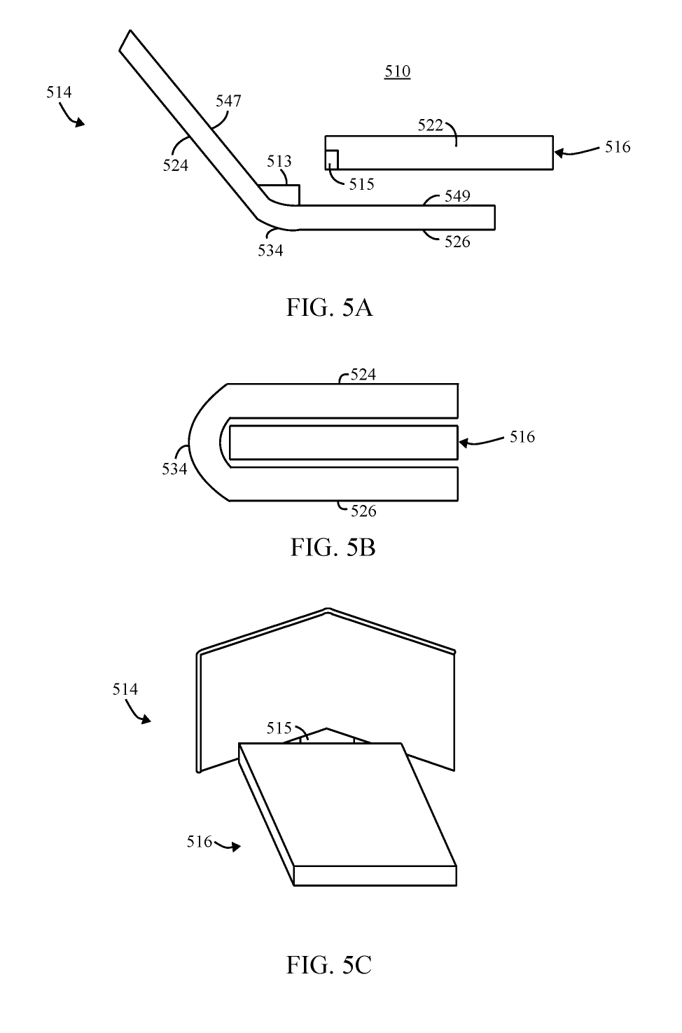

FIG. 5A illustrates an electronic device 510 formed in accordance with an alternative embodiment. The device 510 includes a main base unit 516 that may be detached from a display unit 514. The display unit 514 may be formed in accordance with the various embodiments described herein. In the example of FIG. 5, the display unit 514 includes primary and secondary display segments 524, 526 that have primary and secondary viewing regions 547 and 549. The primary and secondary display segments 524, 526 are connected through an intermediate segment 534. The main base unit 516 includes a connector 515 provided along an edge of the housing 522. The connector 515 is configured to be mated with a corresponding connector 513 provided on the display unit 514.

FIG. 5B illustrates the device 510 when in a closed storage position. During storage, the display unit 514 is disconnected from the main base unit 516, and is folded to wrap around the main base unit 516.

FIG. 5C illustrates the device 510 when in an open position with the main base unit 516 connected to the display unit 514. The main base unit 516 and display unit 514 may be connected through various types of interfaces. For example, the connections 513, 515 may represent a flexible or rigid connector 6. The connector 515 may be configured to mate with an adjoining connector 513 on an edge or other surface of the display unit 514. Optionally, the connectors 513, 515 may represent a wireless link with the main base unit 516 wirelessly conveying display content to the display unit 514.

In accordance with embodiments herein, the electronic device may operation in various modes such as a sleep mode, tablet mode, extended display mode, dual display mode, triple display mode, notifications mode and the like. For example, the electronic device may enter the mode based on an instruction entered by a user or automatically when the display unit moved to a predetermined position. When the electronic device enters a mode, the viewing regions are turned on/off and rendered touch sensitive/insensitive. For example, when in a tablet mode, the secondary viewing region may be utilized as a graphical user interface, both for displaying content and receiving user inputs through a touch sensitive layer. As another example, when in a sleep mode or notifications mode, the secondary viewing region may display notifications content. As a non-limiting example, the notification content may display incoming text messages, email notifications, notifications regarding computer or application updates, and the like.

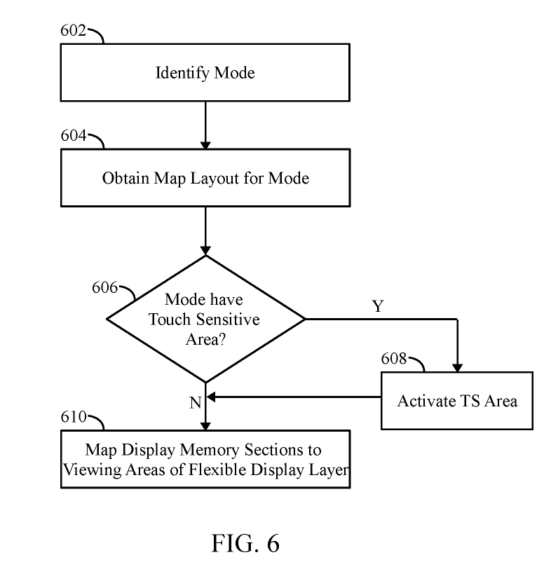

FIG. 6 illustrates a process for configuring a display unit based on an embodiment herein. At 602, one or more processors of the device 110 identify the mode of operation. Non-limiting examples of modes may include a standard mode, a presentation mode, a tablet mode, a dual monitor mode, a notifications mode and a user query mode. As one example, the device 110 may enter a predetermined initial mode when the device 110 is initially powered up and a user logs in. The device 110 may remain in the initial mode until the device “goes to sleep”, powers down, and the like. Optionally, the device 110 may switch modes based on a relative position of the keyboard and the display unit. For example, when the display unit is closed onto the keyboard, the device may automatically switch to a tablet mode. Optionally, the user may provide an instruction to change the mode, such as to switch to a presentation mode, a tablet mode, and the like. Optionally, the device 110 may remain in a mode throughout operation without change.

At 604, the one or more processor of the device 110 obtains a map layout. The map layout may be based on the mode and/or other criteria. The map layouts may be defined at a time that the device 110 is manufactured and/or may be defined/modified with software updates. The map layouts may be uploaded with a display driver. One or more modes of operation may have common or different map layouts. For example, the standard mode may correspond to a standard map layout in which the primary viewing area is the only active viewing area, while the secondary viewing area is deactivated. The presentation mode may correspond to a presentation map layout in which the secondary viewing area displays the same content as the primary viewing area. The tablet mode and/or user query mode may correspond to a tablet or query map layout in which the secondary viewing area is the only active viewing area, while the primary and edge viewing area is deactivated. The notifications mode and/or user query mode may correspond to a notifications and/or query map layout in which the secondary viewing area is active, while the primary viewing area is deactivated.

At 606, the one or more processors of the device 110 determine whether the identified mode includes one or more touch sensitive areas. For example, the tablet mode and/or the presentation mode may include one or more touch sensitive areas (e.g., the primary and/or rear viewing area). When the present mode includes a touch sensitive area, flow moves to 608. Otherwise, flow moves to 610. At 608, one or more touch sensitive areas are activated. For example, when in the presentation mode, a touch sensitive layer within the secondary viewing area may be activated to be touch sensitive. Additionally or alternatively, the standard mode may include activating a touch sensitive layer within the secondary viewing area. Additionally or alternatively, the standard mode (or any other mode) may include activating a touch sensitive layer within the primary viewing area.

At 610, the one or more processors maps sections of the display memory to the corresponding viewing areas. For example, different sections of the display memory are mapped to the primary and secondary viewing regions of the flexible display layer.

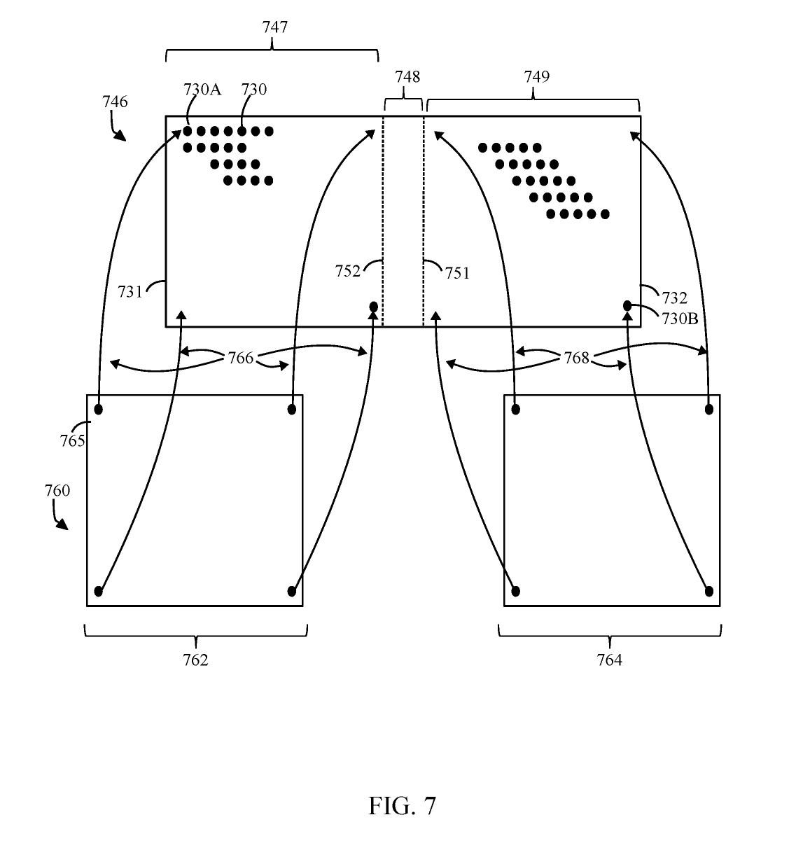

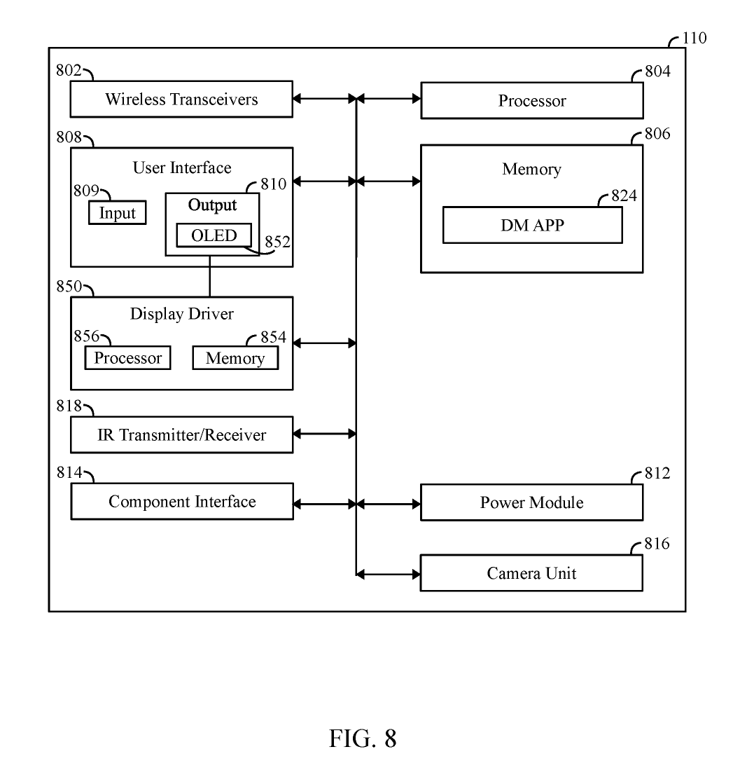

FIG. 7 illustrates a graphical representation of a mapping relation between display memory sections and viewing areas utilized in accordance with an embodiment herein. Within FIG. 7, a flexible display layer 746 is illustrated as an elongated rectangular array of digital pixels (a portion of which are noted as pixels 730). The flexible display layer 746 includes a continuous homogeneous two dimensional (2D) rectilinear array of digital pixels 730 is arranged in rows and columns that traverse the primary and secondary viewing regions between opposite edges 731 and 732 of the flexible display layer 746. The digital pixels 730 are individually addressed by the display driver on a video card. For example, the pixel 730A may correspond to an initial coordinate (0, 0) within the array, while pixel 730B corresponds to a final coordinate (e.g., (2048×768), (4288×2848)).

The flexible display layer 746 is functionally divided into a primary viewing region 747 and a secondary viewing region 749. The secondary viewing region 749 may be further divided into multiple viewing regions. Dashed lines (referred to as functional division lines 751, 752) crossed the flexible display layer 746 to illustrate conceptual division between the functionality of the regions 747, 749. It is recognized that the size of the regions 747, 749 may vary, as well as the overall shape and form factor of the flexible display layer 746. While functionality may differ between the regions 747, 749, the array of pixels within the flexible display layer 746 is uniform across the functional division lines 751, 752.

FIG. 7 also illustrates a display memory 760 that may represent one continuous section of memory or multiple separate sections of memory. The display memory 760 is divided into first and second memory sections 762, 764. During operation, the device rights different types of content to the corresponding first, edge and second memory sections 762, 764 based upon various criteria, such as the nature of the content, the mode of operation and the like. For example, during a standard mode of operation, all visual content may be written to the first memory section 762, without any visual content written to the second memory section 764. During a presentation mode of operation, all visual content may be written to both of the first and second memory sections 762, 764.

FIG. 7 also illustrates an example of a manner by which the first and second memory sections 762, 764 may be mapped to regions of the flexible display layer 746. As one example, the first memory section 762 may be defined to have an array of addresses that are arranged in rows and columns corresponding to the array of pixels 730 within the primary viewing region 747. Continuing with this example, a first memory address 765 in the first memory section 762 may be mapped to a first pixel 730 A in the primary viewing section 747. Rows and columns of addresses within the first memory section 762 are mapped as noted by the arrows 766 to corresponding pixels 730 in the primary viewing section 747.

In the example of FIG. 7, the first and second memory sections 762, 764 are illustrated to mapped to continuous, yet non-overlapping, pixel arrays within the flexible display layer 746. Optionally, one or more of the first and second memory sections 762,764 may be mapped to pixel arrays that are spaced apart from one another by more than one column of pixels. For example, the first and second memory sections 762, 764 may be mapped to arrays of pixels that are spaced apart by a predetermined distance (e.g., corresponding to one or more columns of pixels).

FIG. 8 illustrates a simplified block diagram of internal components of the electronic device 110 configured to manage content display to different regions of a flexible display in accordance with embodiments herein. The device 110 includes components such as one or more wireless transceivers 802, one or more processors 804 (e.g., a microprocessor, microcomputer, application-specific integrated circuit, etc.), one or more local storage medium (also referred to as a memory) 806, a user interface 808 which includes one or more input devices 809 and one or more output devices 810, a power module 812, a component interface 814 and a camera unit 816. All of these components can be operatively coupled to one another, and can be in communication with one another, by way of one or more internal communication links, such as an internal bus. The camera unit 816 may capture one or more frames of image data.

The input and output devices 809, 810 may each include a variety of visual, audio, and/or mechanical devices. For example, the input devices 809 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 810 can include a visual output device, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 810 may include a touch sensitive screen, a non-touch sensitive screen, a text-only display, a smart phone display, an audio output (e.g., a speaker or headphone jack), and/or any combination thereof. Optionally, the input devices 809 may include one or more touch sensitive layers provided on the front and/or rear sides of the display 852. The output devices 810 include a flexible display layer, such as an OLED display 852.

The transceiver 802 can utilize a known wireless technology for communication. Exemplary operation of the wireless transceivers 802 in conjunction with other components of the device 110 may take a variety of forms and may include, for example, operation in which, upon reception of wireless signals, the components of device 110 detect communication signals from secondary devices and the transceiver 802 demodulates the communication signals to recover incoming information, such as responses to inquiry requests, voice and/or data, transmitted by the wireless signals. The processor 804 formats outgoing information and conveys the outgoing information to one or more of the wireless transceivers 802 for modulation to communication signals. The wireless transceiver(s) 802 convey the modulated signals to a remote device, such as a cell tower or a remote server (not shown).

The local storage medium 806 can encompass one or more memory devices of any of a variety of forms (e.g., read only memory, random access memory, static random access memory, dynamic random access memory, etc.) and can be used by the processor 804 to store and retrieve data. The data that is stored by the memory 806 can include, but need not be limited to, operating systems, applications, user collected content and informational data. Each operating system includes executable code that controls basic functions of the device, such as interaction among the various components, communication with external devices via the wireless transceivers 802 and/or the component interface 814, and storage and retrieval of applications and data to and from the memory 806. Each application includes executable code that utilizes an operating system to provide more specific functionality for the communication devices, such as file system service and handling of protected and unprotected data stored in the local storage medium 806.

A display management (DM) application 824 is stored in the memory 806. The DM application 824 includes program instructions accessible by the one or more processors 804 to direct a processor 804 to implement the methods, processes and operations described herein including, but not limited to the methods, processes and operations illustrated in the Figures and described in connection with the Figures. The DM application 824 manages operation of the processor 804, display driver 850 and/or a video card in connection with displaying desired content on the primary and secondary (e.g., edge and/or rear) viewing regions of the flexible display layer.

In accordance with at least one embodiment, a touch sensitive layer is located over the secondary viewing region of the display layer on the back surface of the display unit. The DM application 824 directs the processor to switch to a desired mode. In accordance with at least one embodiment, the processor utilizes the secondary viewing region of the display layer to display one or more of alert content, calendar content, message content, advertisement content, or personalized content.

Other applications stored in the memory 806 include various application program interfaces (APIs), some of which provide links to/from the cloud hosting service. The power module 812 preferably includes a power supply, such as a battery, for providing power to the other components while enabling the device 110 to be portable, as well as circuitry providing for the battery to be recharged. The component interface 814 provides a direct connection to other devices, auxiliary components, or accessories for additional or enhanced functionality, and in particular, can include a USB port for linking to a user device with a USB cable.

Optionally, the device 110 may include an infrared (IR) transmitter/receiver 818 that may be utilized in connection with controlling one or more secondary devices through transmission and reception of IR signals.

A display driver 850 is coupled to the processor 804 and configured to manage display of content on a display 852. The display driver 850 is connected to the primary and secondary viewing regions of the OLED display 852. The display driver 850 writes the desired content to the primary and secondary viewing regions under direction of the main processor 804. Optionally, the display driver 850 includes display memory 854 and one or more display control processors 856. The display memory 854 includes multiple sections, to which the display control processors 856 and/or processor 804 write content to be displayed. The sections of the display memory 854 are mapped to corresponding regions of the flexible display layer. An example of one mapping configuration is discussed herein in connection with FIG. 7. The display driver 850 provides a common display interface for all of the viewing regions within the flexible display layer within the display 852. For example, the display driver 850 manages display of content in the primary and secondary viewing regions.

Optionally, the display driver 850 may omit a separate processor and memory, and alternatively or additionally, utilize sections of the memory 806 as display memory and the processor 804 to manage writing content to a display memory section within the memory 806.

Before concluding, it is to be understood that although e.g. a software application for undertaking embodiments herein may be vended with a device such as the system 110, embodiments herein apply in instances where such an application is e.g. downloaded from a server to a device over a network such as the Internet. Furthermore, embodiments herein apply in instances where e.g. such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. An electronic device, comprising:
a main body unit including a user input, a memory to store program instructions, and a processor to execute the program instructions;
a display unit moveably coupled to the main body unit, the display unit comprising a flexible display layer having primary and secondary viewing regions formed as a monolithic structure, the secondary viewing region foldable relative to the primary viewing region;
the processor to define boundaries for the primary and secondary viewing regions; and
the processor to display content on the primary and secondary viewing regions within the corresponding boundaries.

2. The device of claim 1, wherein the flexible display layer is rotatably coupled to the main body unit proximate to a first boundary of the primary viewing region, the secondary viewing region foldable along a fold line proximate to a second boundary of the primary viewing region.

3. The device of claim 1, wherein the display unit is foldable about a primary lateral axis that extends laterally relative the user input and primary viewing region.

4. The device of claim 3, wherein the secondary viewing region is foldable, relative to the primary viewing region, about a secondary lateral axis that is oriented orthogonal to the primary lateral axis.

5. The device of claim 4, wherein the primary and secondary viewing regions are arranged in a stacked configuration with the primary and secondary lateral axes extending parallel to one another and located along bottom and top boundary of the primary viewing region.

6. The device of claim 3, wherein the primary and secondary viewing regions are arranged in a side-by-side configuration with the secondary viewing region foldable, relative to the primary viewing region, about a vertical axis that is oriented perpendicular to the primary lateral axis.

7. The device of claim 1, wherein the secondary viewing region is divided into first and second viewing regions that are formed as a monolithic structure with the primary viewing region, the first and second viewing regions are provided on opposite lateral sides of the primary viewing region.

8. The device of claim 1, wherein the flexible display layer comprises an intermediate region between the primary and secondary viewing regions, the intermediate region having a fold clearance area, the intermediate region enabling the secondary viewing region to be folded entirely inward until abutting against the primary viewing region and to be folded entirely outward until rear surfaces of the primary and secondary viewing regions are located proximate to one another.

9. The device of claim 1, further comprising a touch sensitive layer located over at least one of the first or secondary viewing regions of the flexible display layer, the touch sensitive layer to provide inputs to the processor.

10. A method, comprising:
providing an electronic device comprising a display unit moveably coupled to a main body unit, the display unit comprising a flexible display layer having primary and secondary viewing regions formed as a monolithic structure, the secondary viewing region foldable relative to the primary viewing region;
under control of one or more processors configured with specific executable program instructions, displaying content on the primary and secondary viewing regions, respectively.

11. The method of claim 10, further comprising enabling the display unit to be foldable about a primary lateral axis that extends laterally relative the primary viewing region; and enabling the secondary viewing region to be foldable, relative to the primary viewing region, about a secondary lateral axis that is oriented orthogonal to the primary lateral axis.

12. The method of claim 10, further comprising enabling the secondary viewing region to be foldable entirely outward until rear surfaces of the primary and secondary viewing regions are located proximate to one another such that the primary and secondary viewing regions face in opposite directions.

13. The method of claim 10, further comprising:
arranging the primary and secondary viewing regions in a configuration in which the primary viewing region is folded to a closed position against the main base unit, corresponding to an intermediate folded position, while the secondary viewing region remains visible; and
operating the secondary viewing region in a tablet mode when in the intermediate folded position.

14. The method of claim 10, arranging the primary and secondary viewing regions to be folded to closed positions against front and back surfaces of the main base unit.

15. The method of claim 14, wherein the primary and secondary viewing regions wrap about top and bottom edges of the main base unit when in the closed position.

16. The method of claim 14, wherein the primary and secondary viewing regions wrap about top and side edges of the main base unit when in the closed position.

17. The method of claim 10 wherein the secondary viewing region includes first and second viewing regions provided along opposite sides of the primary viewing region, the first and second viewing regions wrapping about opposite side edges of the main base unit when in the closed position.

18. A computer program product comprising a non-signal computer readable storage medium comprising computer executable code to:
map sections of a display memory to primary and secondary viewing regions of a flexible display layer, the primary and secondary viewing regions formed as a monolithic structure, the secondary viewing region foldable relative to the primary viewing region; and
write content to corresponding sections of the display memory in connection with displaying the content on the primary and secondary viewing regions.

19. The computer program product of claim 18, further comprising executable code to identify a mode of operation and map the sections of the display memory based on the mode of operation.

20. The computer program product of claim 18, further comprising executable code to activate a touch sensitive layer proximate to the secondary viewing region based on a mode of operation.
